(19) United States
(12) Patent Application Publication
(10) Pub. No.: US 2009/0086992 A1
(43) Pub. Date: Apr. 2, 2009

(54) MICROPHONE CIRCUIT AND CHARGE AMPLIFIER THEREOF

(75) Inventors: Wei-Chan Hsu, Cupertino, CA (US); Li-Te Wu, Taipei (TW); Yann-Ming Way, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/862,301

(22) Filed: Sep. 27, 2007

(51) Int. Cl. H04R 3/00

(52) U.S. Cl. 381/92

(57) ABSTRACT

The invention provides a microphone circuit. In one embodiment, the microphone circuit comprises a microphone, a self-biased amplifier with a finite gain, and a feedback capacitor. The microphone coupled between a ground and a first node generates a first voltage at the first node according to sound pressure. The self-biased amplifier has a positive input terminal coupled to the ground and a negative input terminal coupled to the first node and amplifies the first voltage according to the finite gain to generate a second voltage at a second node. The feedback capacitor coupled between the first node and the second node feeds back the second voltage to the first node. The second voltage is then output to a following module subsequent to the microphone circuit.

### BACKGROUND OF THE INVENTION

1. Field of the Invention

The invention relates to microphones, and more particularly to microphone circuits.

2. Description of the Related Art

Referring to FIG. 1A, a block diagram of a conventional microphone circuit 100 is shown. The microphone circuit 100 comprises a microphone 102, an Electrostatic Discharge (ESD) protection circuit 104, and a following module 108. The microphone 102 detects external sound pressure and converts the sound pressure to a voltage signal Vₒ, which is output to the following module 108 at node 131. In one embodiment, the following module 108 is a pre-amplifier or an analog-to-digital converter (ADC). The ESD protection circuit 104 comprises two inversely connected diodes 112 and 114 and clamps the range of the voltage signal Vₒ to protect input of the following module 108 from electrostatic discharge.

The microphone 102 comprises two conductor plates forming a capacitor 110 with capacitance Cₘ. When sound pressure is imposed on the conductor plates, the distance between the conductor plates varies according to sound pressure to change the capacitance Cₘ of the capacitor 110. Thus, the imposing sound pressure is converted into a voltage signal Vₒ changed according to the capacitance Cₘ of the microphone capacitor 110. Thus, the voltage signal Vₒ output to the following module 108 is mainly determined by the microphone capacitor 110.

The microphone circuit 100, however, comprises other capacitors connected between the node 131 and ground. For example, there is a parasitic capacitance Cₚ between the node 131 and ground. The ESD protection circuit 104 also has a capacitance C_{esd}. In addition, the following module 108 also has an input capacitance C_{g} lying between the node 131 and ground. The capacitance Cₚ, C_{esd}, and C_{g} attenuates the voltage signal Vₒ generated by the microphone 110 and deteriorates the performance of the microphone circuit 100.

Referring to FIG. 1B, an equivalent circuit 150 of the microphone circuit 100 of FIG. 1A is shown. The equivalent circuit 150 comprises a microphone 152 and a parasitic capacitor 154. The microphone 152 equivalent to the microphone 102 of FIG. 1 comprises a voltage source 161 with a voltage level Vₘ and a capacitor 160 with capacitance Cₘ. The parasitic capacitor 154 is coupled between the output node 181 of the microphone 152 and ground and has a capacitance Cₛ equal to (Cₚ+C_{esd}+C_{g}). Thus, the effective output voltage Vₒ received by a following module is determined according to the following algorithm:

$${V}_{o} = \frac{{C}_{m}}{{C}_{m} + {C}_{s}} {V}_{m} . \qquad ( 1 )$$

Thus, the voltage Vₒ is attenuated by a factor of [Cₘ/(Cₘ+Cₛ)]. The larger the parasitic capacitance Cₛ, the smaller the effective output voltage Vₒ. For example, if the parasitic capacitance Cₛ is equal to the microphone capacitance Cₘ, the voltage Vₒ is attenuated by 50%.

To relieve attenuation of the output voltage Vₒ, the parasitic capacitance Cₛ must be reduced. Reduction of the parasitic capacitance Cₛ, however, negatively affects performance of the microphone circuit 100. For example, reduction of the capacitance C_{esd} of the ESD protection circuit 104 decreases the ESD tolerance voltage thereof, and reduction of the input capacitance C_{g} of the following module 108 increases noise carried by the voltage signal Vₒ. Thus, another method for preventing the output voltage Vₒ from attenuation due to the parasitic capacitor 154 is required.

Referring to FIG. 2, a block diagram of a conventional microphone circuit 200 preventing an output voltage Vₒ from attenuation due to a parasitic capacitor 204 is shown. In additional to the microphone 202 and the parasitic capacitor 204, the microphone circuit 200 further comprises a charge amplifier 206 coupled between the microphone 202 and a following nodule. The microphone 202 and the parasitic capacitor 204 are coupled between a node 231 and ground. The charge amplifier 206 comprises an operational amplifier 222, a feedback capacitor 224 with capacitance C_{f}, and a bias circuit 226.

The operational amplifier 222 has a positive input terminal coupled to the ground, a negative terminal coupled to the node 231, and an output terminal coupled to an output node 232. The operational amplifier 222 has a very large gain, typically greater than 1000, which is considered as infinity. The feedback capacitor 224 is coupled between the node 231 and the output node 232. Thus, an output voltage at the output node 232 is determined according to the following algorithm:

$${V}_{o} = - \frac{{V}_{m} \cdot {C}_{m}}{{C}_{f}} . \qquad ( 2 )$$

The output voltage Vₒ of the microphone circuit 200 is therefore independent of the capacitance Cₛ of the parasitic capacitor 204 and free from attenuation of the parasitic capacitance Cₛ.

Because the operational amplifier 222 has an infinite gain, a small DC offset voltage between the negative input terminal and the positive input terminal of the operational amplifier 222 saturates the operational amplifier. To prevent the operational amplifier 222 from saturation, a bias circuit 226 is required. The bias circuit 226 is a resistor 228 connected between the output node 232 and the negative input terminal 231 of the operational amplifier 222. Because the feedback capacitor 224 has a capacitance C_{f} of about a few pF, the bias resistor 228 therefore must have a resistance R of a few GΩ to provide an appropriate −3 dB attenuation point at 1/(2π×R×C_{f}). A resistor with 1 GΩ, however, occupies much integrated chip area and is complex to implement in a semiconductor manufacturing process. Thus, a new method for a microphone circuit to prevent an output voltage from attenuation due to a parasitic capacitor is required.

### BRIEF SUMMARY OF THE INVENTION

The invention provides a microphone circuit. In one embodiment, the microphone circuit comprises a microphone, a self-biased amplifier with a finite gain, and a feedback capacitor. The microphone coupled between a ground and a first node generates a first voltage at the first node according to sound pressure. The self-biased amplifier has a positive input terminal coupled to the ground and a negative input terminal coupled to the first node and amplifies the first voltage according to the finite gain to generate a second voltage at a second node. The feedback capacitor coupled between the first node and the second node feeds back the second voltage to the first node. The second voltage is then output to a following module subsequent to the microphone circuit.

The invention also provides a charge amplifier coupled to a microphone. The microphone generates a first voltage according to sound pressure at a first mode. In one embodiment, the charge amplifier comprises a self-biased amplifier with a finite gain and a feedback capacitor. The self-biased amplifier has a positive input terminal coupled to a ground and a negative input terminal coupled to the first node and amplifies the first voltage according to the finite gain to generate a second voltage at a second node. The feedback capacitor coupled between the first node and the second node feeds back the second voltage to the first node. The second voltage is then output to a following module subsequent to the charge amplifier.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows a block diagram of a conventional microphone circuit;

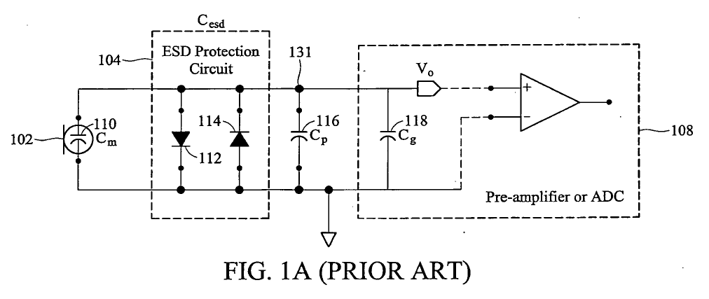

FIG. 1B shows an equivalent circuit of the microphone circuit of FIG. 1A;

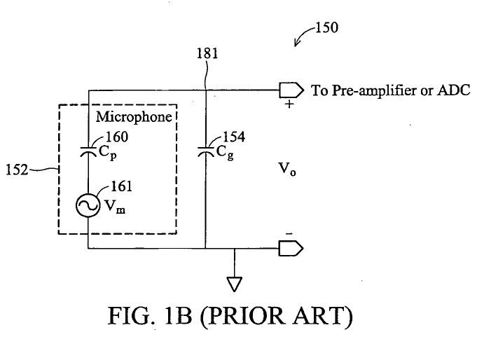

FIG. 2 shows a block diagram of a conventional microphone circuit preventing an output voltage from attenuation due to a parasitic capacitor;

FIG. 3 shows a block diagram of a microphone circuit preventing an output voltage thereof from attenuation due to parasitic capacitance according to the invention;

FIG. 4 shows an equivalent circuit of the microphone circuit of FIG. 3;

FIG. 5 shows a block diagram of a self-biased amplifier according to the invention; and

FIG. 6 shows a block diagram of a microphone circuit comprising a Microelectromechanical System (MEMS) microphone according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

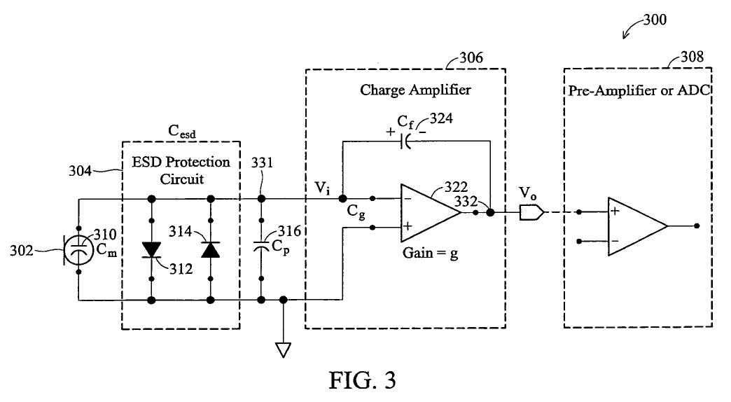

Referring to FIG. 3, a block diagram of a microphone circuit 300 preventing an output voltage Vₒ thereof from attenuation due to parasitic capacitance according to the invention is shown. The microphone circuit 300 comprises a microphone 302, an ESD protection circuit 304, a charge amplifier 306, and a following module 308. The microphone 302 is coupled between a node 331 and a ground and generates a voltage Vᵢ at the node 331 according to sound pressure. In one embodiment, the microphone 302 is an Electret Condenser Microphone (ECM). The ESD protection circuit 304 comprises two diodes 312 and 314 connected between the node 331 and the ground. The output voltage Vᵢ of the microphone 302 is mainly determined by capacitance Cₘ of a microphone capacitor 310. Other capacitances coupled between the node 331 and ground include capacitance C_{esd} of the ESD protection circuit 304 and a parasitic capacitor 316 with capacitance Cₚ.

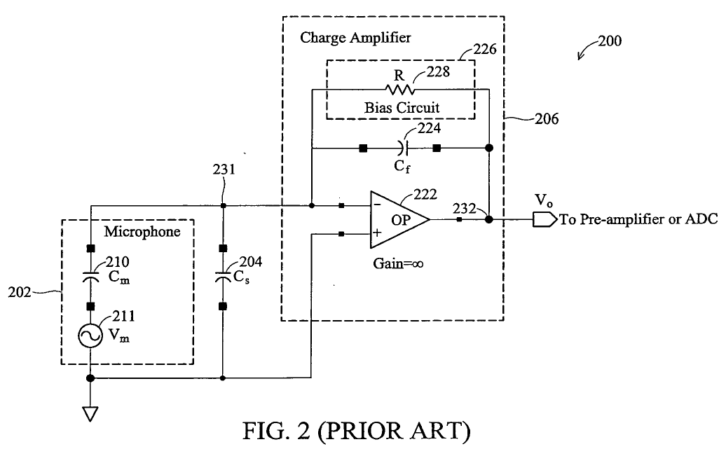

To prevent a voltage received by the following module 308 from attenuation of the parasitic capacitance C_{esd} and Cₚ, a charge amplifier 306 is coupled between the microphone 302 and the following module 308. The charge amplifier 306 comprises a self-biased amplifier 322 and a feedback capacitor 324. Although the charge amplifier 306 of FIG. 3 has a similar structure with the charge amplifier 206 of FIG. 2, there are two differences therebetween. First, unlike the operational amplifier 222 with an infinite gain, the self-biased amplifier 322 has a finite gain g. In one embodiment, the finite gain g has a value between 10 and 100. Secondly, because the gain g of the self-biased amplifier 322 is finite, the charge amplifier 306 does not require a bias circuit, such as the bias resistor 228 of FIG. 2. Thus, the hardware cost of the bias resistor 228 with great resistance is eliminated.

The self-biased amplifier 322 has a positive input terminal coupled to the ground, a negative input terminal coupled to the node 331, and an output terminal coupled to a node 332. The self-biased amplifier 322 amplifies the voltage Vᵢ according to the finite gain g to generate an output voltage Vₒ at the node 332. The feedback capacitor has a capacitance C_{f} and is coupled between the node 331 and the node 332, thus feeding back the output voltage Vₒ to the node 331. The voltage Vₒ is then delivered to the following module 308. In one embodiment, the following module is a pre-amplifier or an ADC.

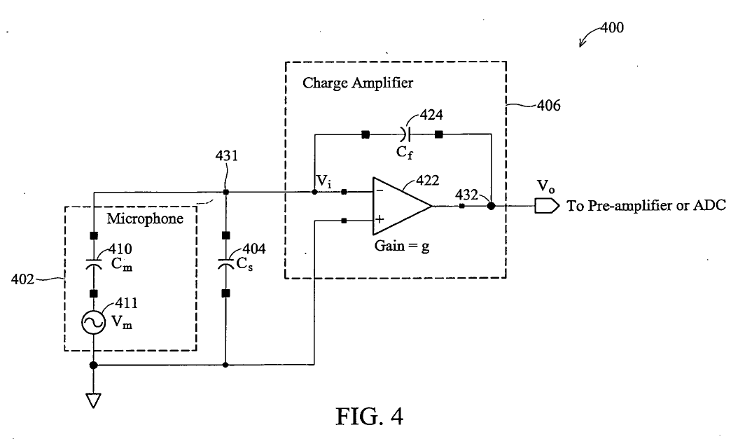

Referring to FIG. 4, an equivalent circuit 400 of the microphone circuit 300 of FIG. 3 is shown. The equivalent circuit 400 comprises a microphone 402, a parasitic capacitor 404, and a charger amplifier 406. The microphone 402 is equivalent to the microphone 300 and comprises a voltage source 411 and a microphone capacitor 410 cascaded between the node 431 and the ground. The voltage source 411 has a voltage value Vₘ and the microphone capacitor 410 has a capacitance Cₘ. The parasitic capacitor 404 has a capacitance Cₛ and represents aggregation of all parasitic capacitance coupled between the node 431 and the ground, such as the parasitic capacitance Cₚ and the ESD capacitance C_{esd} of FIG. 3. The charge amplifier 406 is the same as the charge amplifier 306 and comprises a self-biased amplifier 422 with a finite gain g and a feedback capacitor 424 with capacitance C_{f}.

The output voltage Vₒ generated by the charge amplifier 406 is then determined according to the following algorithm:

$${V}_{o} = - \frac{{C}_{m} \cdot {V}_{m}}{{C}_{f} + \frac{{C}_{s}}{g}} . \qquad ( 3 )$$

Because the range of the finite gain g is between 10 and 100, the parasitic capacitor Cₛ in the denominator of the equation (3) is divided by the gain g and becomes too small to attenuate the output voltage Vₒ. Thus, even if the gain g of the self-biased amplifier 422 is finite, the output voltage Vₒ is mainly determined by the ratio of the microphone capacitance Cₘ to the feedback capacitance C_{f} and free from attenuation of the parasitic capacitance Cₛ.

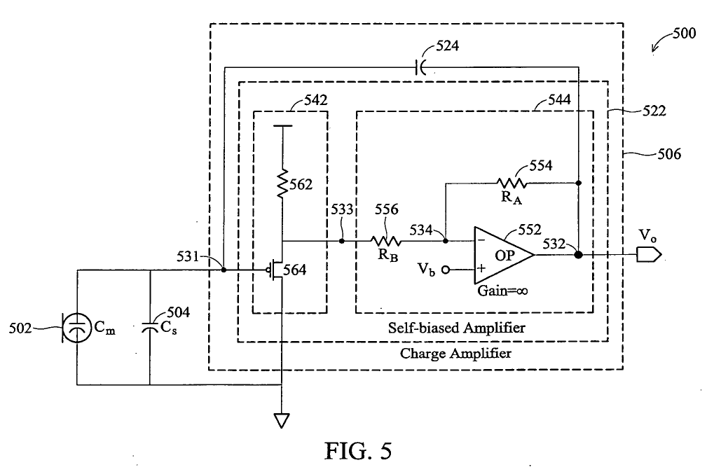

Referring to FIG. 5, a block diagram of a self-biased amplifier 522 according to the invention is shown. The self-biased amplifier 522 has a finite gain g and comprises a source follower circuit 542 and an amplification circuit 544. The source follower circuit 542 comprises a resistor 562 and a PMOS transistor 564. The resistor 562 is coupled between a voltage source and a node 533. The gate of the PMOS transistor 564 is coupled to a node 531 to receive a voltage output by the microphone 502. The drain of the PMOS transistor 564 is coupled to a ground, and the source of the PMOS transistor 564 is coupled to the node 533. Thus, the voltage generated by the microphone 502 is repeated at the node 533.

The amplification circuit 544 comprises two resistors 554 and 556 and an operational amplifier 552. The resistor 556 has a resistance R_{B} and is coupled between the node 533 and a node 534. The resistor 554 is coupled between the node 534 and an output node 532. In addition, the resistor 554 has a resistance R_{A} which is equal to a product of the gain g and the resistance R_{B} of the resistor 556. The operational amplifier 552 has a positive input terminal coupled to a reference voltage V_{b}, a negative input terminal coupled to the node 534, and an output terminal coupled to the output node 532. Thus, an output voltage Vₒ of the amplification module 544 is determined according to the following algorithm:

Vₒ=V_{b}+g·V_{offset}; (4)

wherein V_{offset} is an offset voltage between the positive and the negative terminal of the operational amplifier 522. Unlike the operational amplifier 222 of FIG. 2, because the gain g is finite and ranges from 10 to 100, the operational amplifier does not easily saturate according to the equation (4) if the reference voltage V_{b} is appropriately determined, and no bias circuit is required. Thus, the manufacturing problem of a bias resistor 228 with a resistance greater than 100 MΩ is resolved.

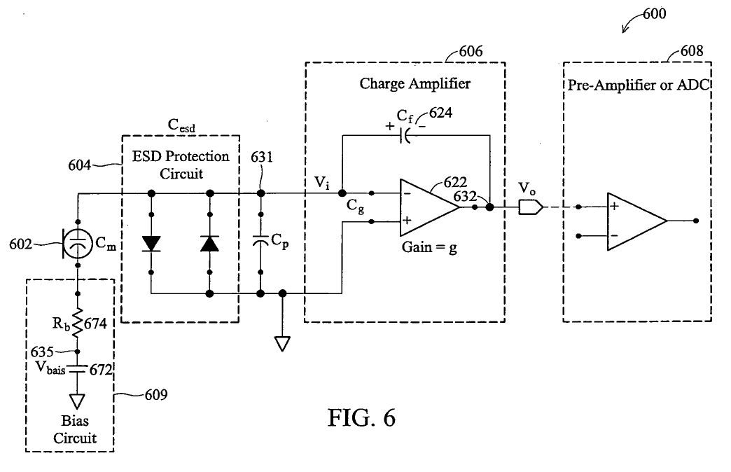

Referring to FIG. 6, a block diagram of a microphone circuit 600 comprising a Microelectromechanical System (MEMS) microphone 602 according to the invention is shown. The microphone circuit 600 is roughly similar to the microphone circuit 300 of FIG. 3, except for the MEMS microphone 602 and a bias circuit 609. The bias circuit 609 is coupled between the MEMS microphone 602 and the ground and supplies charges required by the MEMS microphone 602. In one embodiment, the bias circuit 609 comprises a resistor 674 and a charge pump circuit 672. The resistor 674 is coupled between the MEMS microphone 602 and a node 635. The charge pump circuit 672 is coupled between the node 635 and the ground and provides a bias voltage V_{bias} at the node 635. Because the charge amplifier 606 comprises a self-biased amplifier 622 with a finite gain g as the charge amplifier 322 of FIG. 3, the output voltage Vₒ received by the following module 608 is barely affected by parasitic capacitance Cₚ, and the charge amplifier 606 requires no bias circuit.

The invention provides a microphone circuit comprising a self-biased amplifier with a finite gain, wherein the finite gain ranges from 10 to 100. Because the finite gain is much greater than 1, the output voltage Vₒ of the microphone circuit is barely affected by parasitic capacitance. Because the finite gain is much smaller than ordinary gain (>1000) of an operational amplifier, no bias resistor is required, solving the problem of manufacturing the bias resistor with a resistance of a few GΩ.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone circuit, comprising:
a microphone, coupled between a ground and a first node, generating a first voltage at the first node according to sound pressure;
a self-biased amplifier with a finite gain, having a positive input terminal coupled to the ground and a negative input terminal coupled to the first node, amplifying the first voltage according to the finite gain to generate a second voltage at a second node; and
a feedback capacitor, coupled between the first node and the second node, feeding back the second voltage to the first node;
wherein the second voltage is output to a following module subsequent to the microphone circuit.

2. The microphone circuit as claimed in claim 1, wherein the finite gain ranges between 10 and 100.

3. The microphone circuit as claimed in claim 1, wherein the self-biased amplifier comprises:
a source follower circuit, coupled between a voltage source, the ground, and the first node, generating the first voltage at a third node; and
an amplification circuit, coupled between the third node and the second node, amplifying the first voltage at the third node according to the finite gain to generate the second voltage at the second node.

4. The microphone circuit as claimed in claim 3, wherein the amplification circuit comprises:
a first resistor, coupled between the third node and a fourth node, having a first resistance;
a second resistor, coupled between the fourth node and the second node, having a second resistance equal to a product of the first resistance and the finite gain; and
an operational amplifier, having a positive input terminal coupled to a reference voltage, a negative input terminal coupled to the fourth node, and an output terminal coupled to the second node.

5. The microphone circuit as claimed in claim 3, wherein the source follower circuit comprises:
a third resistor, coupled between the voltage source and the third node; and
a transistor, having a gate coupled to the first node, a source coupled to the third node, and a drain coupled to the ground.

6. The microphone circuit as claimed in claim 5, wherein the transistor is a PMOS transistor.

7. The microphone circuit as claimed in claim 1, wherein the microphone is an Electret Condenser Microphone (ECM).

8. The microphone circuit as claimed in claim 1, wherein the microphone is a Microelectromechanical System (MEMS) microphone, and the microphone circuit further comprises a bias circuit, coupled between the microphone and the ground, supplying charges required by the microphone.

9. The microphone circuit as claimed in claim 8, wherein the bias circuit comprises:
a fourth resistor, coupled between the microphone and a fifth node; and
a charge pump circuit, coupled between the fifth node and the ground, providing a bias voltage at the fifth node.

10. The microphone circuit as claimed in claim 1, wherein the microphone circuit further comprises an Electrostatic Discharge (ESD) protection circuit coupled between the first node and the ground.

11. The microphone circuit as claimed in claim 1, wherein the ESD protection circuit comprises:
a first diode, having an anode coupled to the first node and a cathode coupled to the ground; and
a second diode, having a cathode coupled to the first node and an anode coupled to the ground.

12. The microphone circuit as claimed in claim 1, wherein the following module is a pre-amplifier or an analog-to-digital converter.

13. A charge amplifier, coupled to a microphone generating a first voltage according to sound pressure at a first mode, comprising:
a self-biased amplifier with a finite gain, having a positive input terminal coupled to a ground and a negative input terminal coupled to the first node, amplifying the first voltage according to the finite gain to generate a second voltage at a second node; and
a feedback capacitor, coupled between the first node and the second node, feeding back the second voltage to the first node;
wherein the second voltage is output to a following module subsequent to the charge amplifier.

14. The charge amplifier as claimed in claim 13, wherein the finite gain ranges between 10 and 100.

15. The charge amplifier as claimed in claim 13, wherein the self-biased amplifier comprises:
a source follower circuit, coupled between a voltage source, the ground, and the first node, generating the first voltage at a third node; and
an amplification circuit, coupled between the third node and the second node, amplifying the first voltage at the third node according to the finite gain to generate the second voltage at the second node.

16. The charge amplifier as claimed in claim 15, wherein the amplification circuit comprises:
a first resistor, coupled between the third node and a fourth node, having a first resistance;
a second resistor, coupled between the fourth node and the second node, having a second resistance equal to a product of the first resistance and the finite gain; and
an operational amplifier, having a positive input terminal coupled to a reference voltage, a negative input terminal coupled to the fourth node, and an output terminal coupled to the second node.

17. The charge amplifier as claimed in claim 15, wherein the source follower circuit comprises:
a third resistor, coupled between the voltage source and the third node; and
a transistor, having a gate coupled to the first node, a source coupled to the third node, and a drain coupled to the ground.

18. The charge amplifier as claimed in claim 17, wherein the transistor is a PMOS transistor.

19. The charge amplifier as claimed in claim 13, wherein the microphone is an Electret Condenser Microphone (ECM) or a Microelectromechanical System (MEMS) microphone.

20. The charge amplifier as claimed in claim 13, wherein the following module is a pre-amplifier or an analog-to-digital converter.
